(19) United States
(12) Patent Application Publication
(10) Pub. No.: US 2006/0101964 A1
(43) Pub. Date: May 18, 2006

(54) Rotary die cutter

(76) Inventor: Ramon Serrra Obiol, Barcelona (ES)

Correspondence Address: EGBERT LAW OFFICES, 412 MAIN STREET, 7TH FLOOR, HOUSTON, TX, 77002, US

(21) Appl. No.: 10/535,807

(22) PCT Filed: Nov. 27, 2003
(86) PCT No.: PCT/ES03/00603

§ 371 Date: Dec. 12, 2005

(30) Foreign Application Priority Data
Nov. 28, 2002 (ES) P 200202736

(51) Int. Cl. B23D 25/12; B26D 5/08

(52) U.S. Cl. 83/343; 83/346; 83/559

(57) ABSTRACT

The invention relates to a rotary die cutter. The inventive die cutter includes a bench, a belt which is disposed on the aforementioned bench and which operates by friction at the rear of the pulley of a polyurethane cylinder, a cogged belt which extends from the motor, a variable-speed motor which is disposed on the electrical axis with the die-holder cylinder, an auxiliary motor and a shaft which are used to actuate screws used to lift the polyurethane cylinder, and a reduction gear box having a screw for lifting the aforementioned polyurethane cylinder.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention has its application within the industry dedicated to the manufacture of tools in general, and die cutters in particular.

### BACKGROUND OF THE INVENTION

Machines for rotary die cutting of laminate material, such as corrugated cardboard, are basically made up of two rollers, one of which holds the die and works against the other roller, generally manufactured in steel or coated in polyurethane.

When work is performed against the polyurethane, the steel threads of the dies penetrate the surface in 1 or 2 millimeters, which implies producing a totally irregular wear.

In dies used for manufacturing corrugated cardboard boxes there are, as well as the blades intended for cutting the sheet, rounded blades which are blades without a rib for the creasing thereof.

The irregular wear of the polyurethane produces false creases when the rounded blades strike in the areas deteriorated by the blades.

The aforementioned entails, in short, a lack of uniformity in the polyurethane wear, such wear producing poor die-cutting, both in the cutting and in the creasing of the sheets, producing a problem with respect to the quality of the product thus obtained.

One of the contributions made by machinery manufacturers for the purpose of reducing the problem mentioned above consists in providing the polyurethane cylinders with an axial shifting ranging between +/−20 millimeters, which entails preventing the circumferential blades from always hitting on the same place.

Another action or improvement performed on this type of machine for the purpose of improving the polyurethane surface consists in turning or rectifying the very surfaces by means of a cutting tool, reducing the whole cylinder both in the affected parts and in the new parts, producing a notable reduction in the useful life of the polyurethanes.

Currently, there is frequent rotation of the polyurethanes, which are separated and provide the possibility of removing a ring from one of the ends so as to shift the rest of the rings and assemble it on the other end, and thus repeatedly until reaching the end of the useful life of the polyurethanes due to wear and loss of thickness.

These polyurethane parts are notably thin bands of about 200 millimeters which envelope the cylinder and are held by pressure in runners incorporated on the cylinders, and levers and mallets are used to remove these cylinders, making these operations notably uncomfortable.

It must be indicated that a uniform wear in the polyurethane surfaces is not achieved with these processes or arrangements, given that when a circular blade has been striking on polyurethane it produces a groove thereon which, with axial shifting, becomes a centimeter band, and with the rotation of the bands, all the parts end up with equal wear in a similar area.

The evident solution to the current drawbacks in this area would be to have a rotating die cutter in which the anomalies set forth above would be solved.

However, the applicant is unaware of the current existence of an invention having suitable features for solving the drawbacks set forth.

### BRIEF SUMMARY OF THE INVENTION

The present specification refers to a Patent of Invention application corresponding to a rotary die cutter, configured by means of two cylinders, in one of which the die is assembled and the other in which the polyurethane is assembled, having a polyurethane cylinder with a notably greater length than the width of the machine, which is capable of axial shifting, having two polyurethane rings configured as ring elements formed by two differentiated parts.

The rotary die cutter proposed by the invention has a plurality of advantages with respect to conventional die cutters, managing to eliminate the problems set forth above.

More specifically, the rotary die cutter object of the invention is constituted from a bed-plate, chassis or frame in which the constituting elements thereof are incorporated, such as can be a polyurethane-holding cylinder, whole polyurethane rings, rings for polyurethane fixing, bearing-holder, rubber-coated pulley, etc., as well as the pertinent motors.

It must be indicated that in this invention the polyurethane cylinder is notably longer than the width of the machine and has the quality of going through the frames, being able to axially shift about 400 millimeters.

The polyurethane rings are not bands as in conventional machines, but rings or circular annular elements without partitions of 200 to 250 millimeters, which entails preventing defective die cutting at the seams and reducing manufacturing costs.

The removing, shifting and assembling of the rings is substantially easy, with no need for using mallets or levers.

The polyurethane rings are made up of two differentiated parts, given that one of the rings is made of nylon, plastic or the like, coated in polyurethane with a hardness ranging between 90° to 95° Shore, and with the whole ring the price is notably reduced and manufacture thereof simplified.

### BRIEF DESCRIPTION OF THE SEVERAL VIEWS OF THE DRAWINGS

To complement the description being made and for the purpose of aiding towards a better comprehension of the features of the invention, a set of drawings is attached to the present specification, as an integral part thereof, wherein the following has been represented with an illustrative and non limiting character:

FIG. 1 shows a view of the rotary die cutter object of the invention, seen from the front or entrance area.

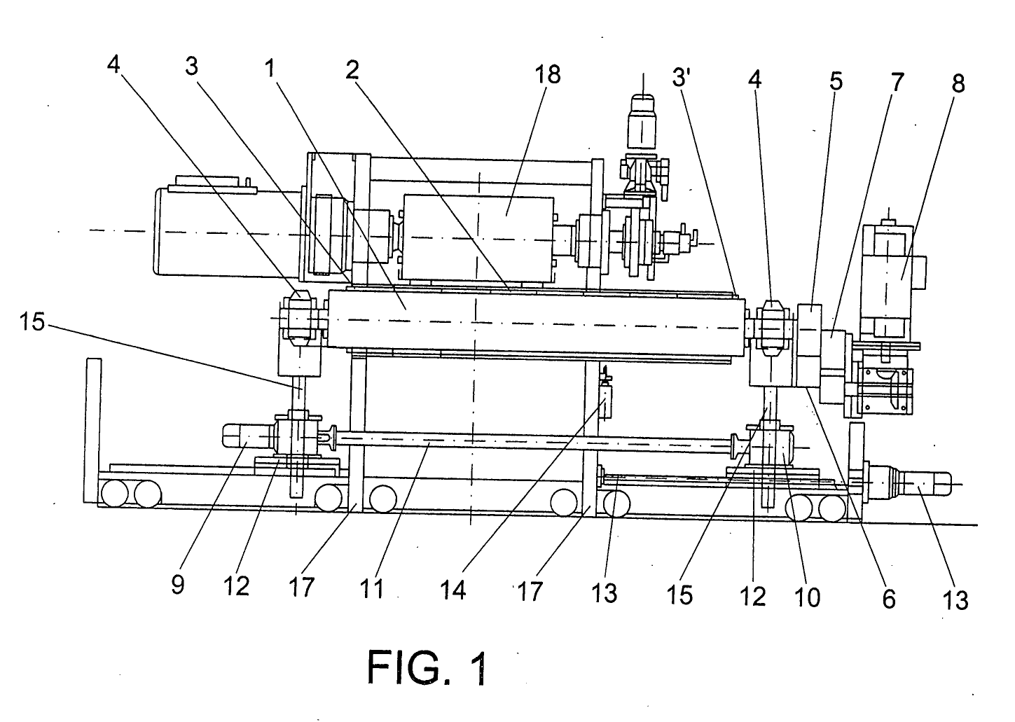

FIG. 2 shows a view of the object represented in FIG. 1 in an end of phase position.

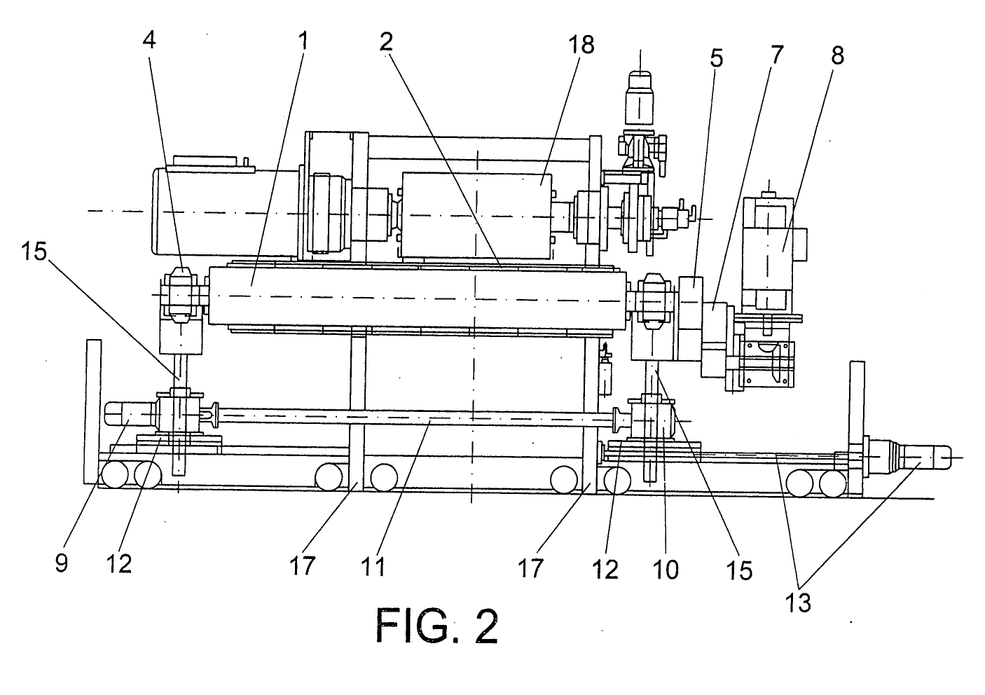

FIG. 3 shows a right side view of the object shown in the previous figures.

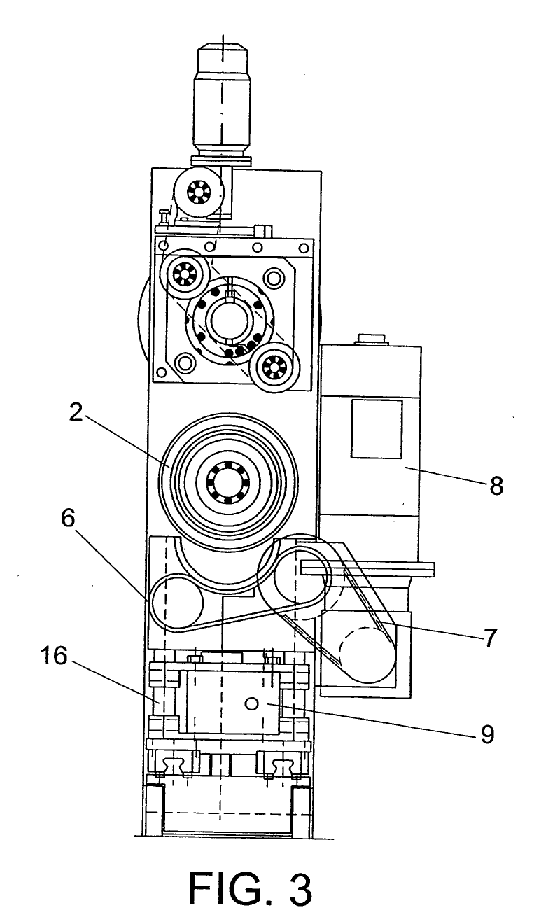

FIG. 4 shows a view of the invention in the lower position for the change.

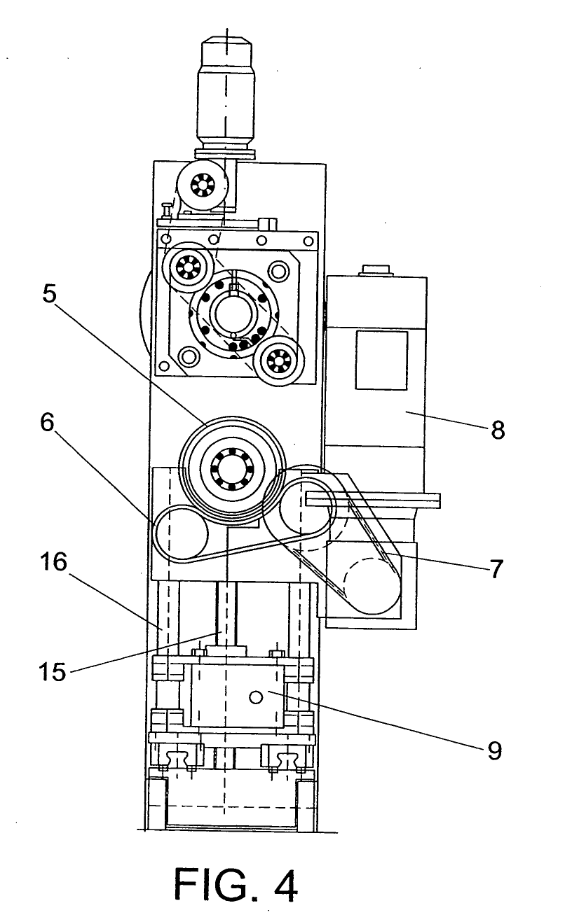

### DETAILED DESCRIPTION OF THE INVENTION

In view of these figures, the rotary die cutter set forth is constituted from a bedplate (17), on which a polyurethane-holding cylinder (1) is assembled, as well as whole polyurethane rings (2), and rings (3) and (3′) for fixing the polyurethane, having a bearing-holder (4), a rubber coated pulley (5), a cogged belt (6), the outer face of which cooperates with the pulley of the polyurethane cylinder (1) to operate said cylinder (1), the die cutter having an incorporated cogged belt (7) operated by the variable speed motor (8) which acts upon the rubber coated pulley (5), incorporating, as mentioned above, a variable speed motor (8) with a shaft electrically operated with the die-holding cylinder (18).

The invention incorporates a motor (9) and a shaft (11) for operating the lifting screws (15) of the polyurethane cylinder (1), as well as two gearboxes (10) with screws for lifting the polyurethane cylinder (1), two sliding plates (12) on guides with linear bearings, a screw (13) with a motor (13′) for the axial shifting of the polyurethane cylinder (1), a pneumatic cylinder (14) for operating the stop holding the polyurethane rings in the shifting thereof along the cylinder and a lifting screw (15) of the polyurethane cylinder (1), guide columns (16) for lifting the polyurethane cylinder (1).

The cycle starts with the polyurethane roller (1) and during machine operation the polyurethane cylinder (1) rotates and axially shifts in a controlled and very slow manner, according to the forward movement pre-selected by the operator and the rotating speed of the machine.

The axial shifting of the polyurethane cylinder (1) is performed on the linear guides with linear bearings and by means of a screw operated by an alternating current motor with speed variation, and when the polyurethane cylinder (1) has shifted along its entire run, the machine emits a warning signal for the operator to decide whether to stop the machine and rotate the polyurethanes or whether to reverse the axial direction of the cylinder to an appropriate position.

1. A rotary die cutter, of a type intended for working on a surface and body of cardboard sheets, said rotary die cutter comprising:
a bedplate in which a polyurethane-holding cylinder is incorporated, with whole polyurethane rings, having rings fixing polyurethane elements; and
a bearing-holder, as well as a pulley coated in rubber, incorporating a cogged drive belt; wherein an outer face of the cogged belt cooperates with the polyurethane cylinder pulley to operate the polyurethane cylinder; and
a cogged belt from a motor to the pulley, the motor comprising a shaft which operates the die-holder cylinder, having a motor and a shaft operating lifting screws of the polyurethane cylinder, as well as two gearboxes to which one of the lifting screws for lifting the polyurethane cylinder is coupled, having two sliding plates on guides with linear bearings, a screw and a motor for axial shifting of the polyurethane cylinder, a pneumatic cylinde operating a stop holding the polyurethane rings in shifting thereof along the cylinder, as well as columns comprising guides in lifting of the polyurethane cylinder, and a die-holder cylinder.

2. A rotary die cutter according to claim 1, wherein said polyurethane cylinder has dimensions exceeding width of the machine, going through the frames and axially shifting about 400 millimeters.

3. A rotary die cutter according to claim 1, wherein said polyurethane rings are configured as circular rings without partitions, being comprised of two differentiated parts configured as a ring of nylon, plastic or the like coated in polyurethane with a hardness of 90° to 95° Shore.
